(19) United States
(12) Patent Application Publication
(10) Pub. No.: US 2007/0022248 A1
(43) Pub. Date: Jan. 25, 2007

(54) Method and device for controlling a cache memory

(75) Inventor: Ram Krishna Ghildiyal, Gurgaon (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/489,434

(22) Filed: Jul. 20, 2006

(30) Foreign Application Priority Data
Jul. 20, 2005 (IN) 967/CHE/2005

(51) Int. Cl. G06F 12/00

(52) U.S. Cl. 711/122

(57) ABSTRACT

A computer cache memory comprises a memory device comprising a plurality of parts, a probe device for probing the memory parts for a cache hit, a ranking device for ranking each of the memory parts; and a data fetching device for fetching data from a higher level of memory into the lowest ranked memory part when there is a cache miss. A method of providing a cache memory comprises providing a memory comprised of a plurality of parts, and maintaining a ranking for each part of cache hits to the respective part.

### BACKGROUND OF INVENTION

Computer systems continue to face the so-called “memory wall problem”, where the performance of applications is increasingly determined by memory latency. Processor speeds continue to grow at a rate of 55% a year, whereas the memory speeds only grow at a rate of 7% a year. Today, a processor has to pay a penalty of several hundred cycles to fetch a block from the main memory to its cache. In the future, the latency will increase to thousands of cycles. It is increasingly difficult to hide the penalty of accessing the main memory. Although using larger cache sizes help in reducing cache misses, they are also becoming increasingly inefficient.

Whenever a processor loads a data item or an instruction, the memory unit of the processor seeks the data in the processor cache. If the data or instruction is available in the cache, it is termed a cache hit and data is immediately loaded into the processor register. If the data is not available in the cache, it is termed a cache miss and the data first has to be loaded to cache and then to the processor. Since data has to be loaded from memory to cache and then to the processor register, it has a penalty normally referred to as cache miss penalty. Average memory access time is a useful measure to evaluate the performance of a cache.
avg_access_time=hit time+miss rate×miss penalty

This measure tells us how much of a penalty, on average, the memory system imposes on each access and can easily be converted into clock cycles for a particular CPU. There may be different penalties for Instruction and Data accesses. Fast machines are significantly affected by cache miss penalties. The increasing speed gap between CPU and main memory has made the performance of the cache system increasingly important.

Some of the methods for reducing the average memory access time are reducing the cache miss rate, reducing the cache miss penalty and reducing the time to hit in a cache.

The first access to a data block cannot be in the cache and is therefore called a cold start miss or a first reference miss. Cold start misses are compulsory misses and are suffered regardless of the cache size.

Once the cache has been fully loaded, if the cache is too small to hold all of the blocks needed during execution of a program, misses occur on blocks that need to be loaded subsequently. In other words, this is the difference between the compulsory miss rate and the miss rate of a finite size fully associative cache. A fully associative cache can use data from any address by using the whole address as a tag. Such misses are called capacity misses. If the cache has sufficient space for the data, but the block can not be kept because the set is full, a conflict miss will occur. These misses are also called collision or interference misses.

To reduce cache miss rate, it is necessary to eliminate some of the misses due to capacity, conflict and collision.

Capacity misses cannot be reduced significantly except by making the cache larger. It is possible however, to reduce the conflict misses and compulsory misses in several ways. Larger blocks decrease the compulsory miss rate by taking advantage of spatial locality. However, they may increase the miss penalty by requiring more data to be fetched per miss. In addition, they will almost certainly increase conflict misses since fewer blocks can be stored in the cache, and maybe even capacity misses in small caches.

Small blocks have a higher miss rate and large blocks have a higher miss penalty (even if miss rate is not too high). High latency, high bandwidth memory systems encourage large block sizes since the cache gets more bytes per miss for a small increase in miss penalty. 32-byte blocks are typical for 1-KB, 4-KB and 16-KB caches while 64-byte blocks are typical for larger caches.

Conflict misses can be a problem for caches with low associativity (especially direct-mapped). A direct-mapped cache of size N has the same miss rate as a 2-way set-associative cache of size N/2. However, there is a limit-higher associativity means more hardware and usually longer cycle times (increased hit time). In addition, it may cause more capacity misses. Nobody uses more than 8-way set-associative caches today, and most systems use 4-way or less. The problem is that the higher hit rate is offset by the slower clock cycle time.

A victim cache is a small (usually, but not necessarily) fully-associative cache that holds a few of the most recently replaced blocks or victims from the main cache. It can improve hit rates without affecting the processor clock rate.

This cache is checked on a miss before going to main memory. If the data block is found, the victim block and the cache block are swapped. It can reduce capacity misses but is best at reducing conflict misses.

Pseudo-associative caches use a technique similar to double hashing. On a miss, the cache searches a different set for the desired block. The second (pseudo) set to probe is usually found by inverting one or more bits in the original set index. Note that two separate searches are conducted on a miss. The first search proceeds as it would for direct-mapped cache. Since there is no associative hardware, hit time is fast if it is found the first time. While this second probe takes some time (usually an extra cycle or two), it is a lot faster than going to main memory. The secondary block can be swapped with the primary block on a “slow hit”. This method reduces the effect of conflict misses. Also improves miss rates without affecting the processor clock rate.

Pseudo-associative caching has a penalty of a second search if a cache miss occurs at the second time also. Although, it improves the cache miss rates, it adds extra burden of second probe if the block swapping on slow hit is not implemented. If block swapping is implemented, this method penalizes the primary hit of some other hit for a second probe. Moreover, if the two data items are accessed one after other, this technique also adds an additional burden of block swapping, every time a block goes for a second probe.

### BRIEF DESCRIPTION OF THE DRAWINGS

In order for the invention to be more readily understood, embodiments of the invention will now be described, by way of example only, with reference to the accompanying drawings, in which:

FIG. 1 is a schematic block diagram of a memory architecture of a computer.

FIG. 2 shows a schematic flow chart of a method of providing an N-way pseudo set associative cache.

FIG. 3 shows a schematic flow chart of an embodiment of an update ranking process of the method of FIG. 1.

FIG. 4 shows a detailed schematic flow chart of a method.

FIG. 5 is a schematic block diagram showing some bits of an address used for an index and some bits used as a TAG.

### DETAILED DESCRIPTION OF PREFERRED EMBODIMENTS

There will be described a method of controlling a cache memory comprising providing a memory device comprised of a plurality of cache memory parts; probing the memory parts for a cache hit; ranking each of the memory parts; and fetching data from a higher level of memory into the lowest ranked memory part when there is a cache miss. Typically the memory device will be divided into the plurality of parts. Each part will contain one or more blocks of data.

A hash index may be generated to provide an offset of the data stored in each part of the memory device. The start of each block of memory stored in each part of the memory device is indexed with the memory location of the block of data. A memory location sought is checked against the index to determine whether the data at the memory location is contained in one of the parts of the memory device (cache hit).

In the event of a cache hit in one of the parts of the memory device the one part is ranked highest. In the event of a cache miss the part into which the data is fetched from higher level memory is ranked highest. In the event that there is a new highest ranked part, the ranking of the remaining parts is decreased. In the event of a cache hit and there being no new highest ranked part the ranking remains the same. Also, in the event that there is more than one of the parts with equal lowest ranking then one of the parts is chosen into which data is fetched from a higher level of memory. The remaining parts are unchanged.

In one embodiment a flag is provided to indicate a repeat cache hit, a new most recent part cache hit or a cache miss. Typically the flag is used to determine whether the ranking of memory parts requires updating. In the event of a repeat cache hit an update is not required. In the event of a new most recent part cache hit or a cache miss then an update is required.

A computer cache memory will also be described comprising a memory device comprising a plurality of parts; a probe device for probing the memory parts for a cache hit; a ranking device for ranking each of the memory parts; and a data fetching device for fetching data from a higher level of memory into the lowest ranked memory part when there is a cache miss. The ranking is according to how recently a memory part is accessed and how frequently the memory part is accessed.

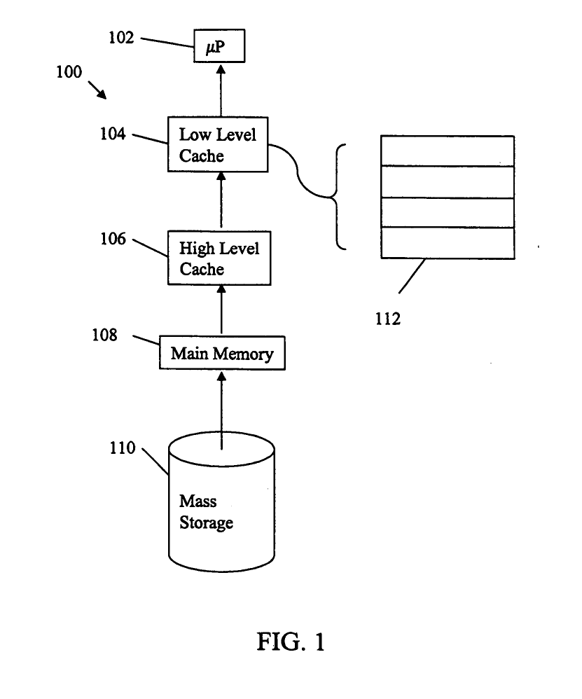

Referring to FIG. 1, typical computer memory architecture 100 is shown. The architecture includes a microprocessor 102 which obtains data from a low level computer cache memory 104. The low level cache memory 104 may be on the microprocessor's die, may be contained within the chip package or may be provided externally. It is currently typical for the lowest level of cache to be provided on the chip die and operate at the microprocessor core clock speed. The low level cache 104 may obtain data from a higher level computer cache memory 106. A high level cache 106 may also be provided on die, in the chip package or externally. Typically, it will also be on die and may run at a clock speed of the computer bus. The high level computer cache memory 106 obtains its data from the main memory 108 of the computer 100. In a typical workstation computer the main memory is provided by DRAM of one of the various types available. The main memory 108 obtains its data from a mass storage device 110, such as a hard disk drive. The present technique may be implemented in any of the memories between the microprocessor 102 and mass storage device 110, but would typically be provided in the low level cache 104 and/or the high level cache 106.

In this example the technique is implemented in the low level cache 104. The cache memory 104 is divided into a number of parts as schematically represented by 112 so as to provide a N-way pseudo set associative cache as will be further described below. In this example 112 is divided into four parts, thus N is four and the cache is a four way pseudo set associative cache.

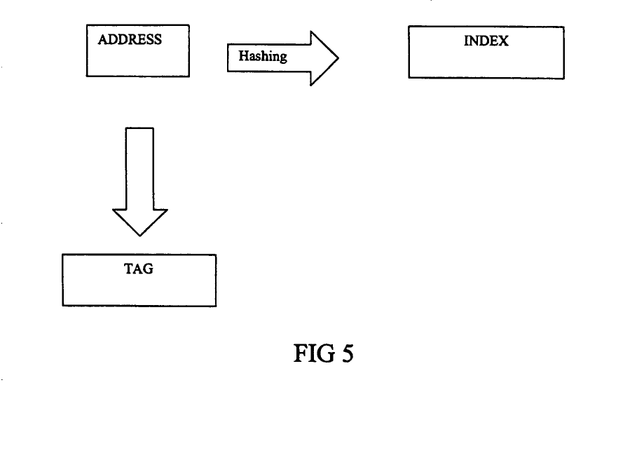

An address of a piece of data, usually a word, is a series of bits that represent the location of the data in the main memory. It is typical for current addresses to be either 32 or 64 bits long. Larger or smaller address sizes are known. Some bits of an address are used to generate an index into the cache using hashing. The other bits are used as a TAG to identify whether an entry corresponding to the above index belongs to the given address. This is represented schematically in FIG. 5.

The following table illustrates the format of the memory structure.

| INDEX | Data (cache line) | TAG bits | Other bits |
|---|---|---|---|
| 1 | | | |
| 2 | | | |
| . | | | |
| . | | | |
| . | | | |
| n | | | |

Set Associative Cache

In a N-way set associative cache, a single index is generated for N entries in the cache. The TAG bits are used to find the correct entry belonging to an address. A replacement policy is used to identify the entry (out of N) that would be overwritten if all of the entries are valid. The table below illustrates this.

| INDEX | Data (Cache line) | TAG bits | Other bits |
|---|---|---|---|
| 1 | | | |
| n | | | |

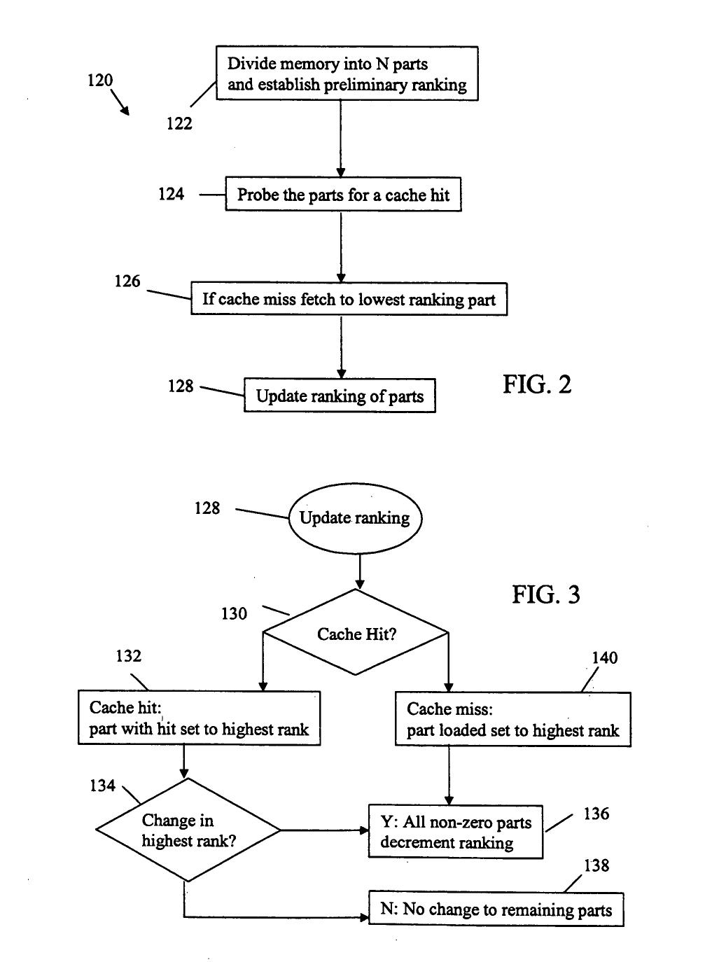

Referring to FIG. 2 there is shown a method 120 of providing a cache memory according to the present technique, specifically so as to provide a N-way pseudo set associative cache. The method commences by providing a low level fast access memory in which addressed data is sought by a computer processor. The memory is divided at 122 into a number of parts, for example 4 parts as represented by 112. It will be appreciated that other numbers may be used, for example a number from 2 to 16. The number is not limited to 16. Each part has a ranking associated with it. Initially the ranking of all of the parts is the lowest ranking value, typically 0.

At 124 each part is parallel probed to determine whether a desired memory address is contained within one of the parts. If a memory address is contained within one of the memory parts it is regarded as cache hit for that memory part. In the event that there is no cache hit the memory part with the lowest ranking part is loaded at 126 with data (usually a block of data) from a higher level of memory (such as a higher level of cache memory 106 or main memory 108). In the event of all of the parts having an equally low ranking, which is regarded as a cold start cache miss one of the parts is chosen.

The memory part which has the cache hit or that is loaded from higher level memory provides the data at the sought address to the processor 102.

At 128 the ranking of each of the memory parts is updated. The updating process is described in more detail in relation to FIG. 3.

In FIG. 3, the memory part ranking update process 128 for all of the parts is shown. At 130, if the probe resulted in a cache hit 132, the memory part that had the hit is set to the highest ranking if it is not already at the highest ranking. Typically the highest ranking is equal to one less than the number of memory parts. For example if there are four memory parts the highest ranking is three. At 134, if there is a change in the highest ranking, then at 136 all non zero ranked parts are decreased in ranking by one. If there is no change in the highest ranking, then at 138 there is no change in the ranking of the other parts.

At 130 if there is a cache miss, the process proceeds to 140 where the part that is loaded from the next highest level of memory is set to the highest rank. All of the remaining memory parts' rankings which are not at the lowest ranking level are being decremented by one. Those that are the lowest level, typically 0, are not decremented further.

The N-way pseudo set-associative cache is configured as follows. The cache memory is segmented into N parts. Then N−1 hash indices are generated from a primary hash index generated from the address. In one embodiment, this can be achieved by dividing the cache into N parts and generating the hash indices that are at a constant offset in each part. This can be done using modulo hashing as follows:

Suppose the cache is divided into N parts and the hash index generated from the address is x. That means the primary hash location is x.

Now the offset of x in the part to which it belongs would be y=mod(x, size of a part), which is essentially the remainder of x/(size of a part). Where s=size of a part=cache size/N.

The N hash locations therefore would be
y,y+s,y+2s,y+3s, . . . ,y+(N−1)s
and for certain p x would be equal to y+p.s.

The following table demonstrates this.

| Index | Access count | Data block | Tag |
|---|---|---|---|
| . . . | . . . | . . . | . . . |
| . . . | . . . | . . . | . . . |
| y | N − 1 | XXXXXXX | XXXXXXXX |
| . . . | . . . | . . . | . . . |
| . . . | . . . | . . . | . . . |
| . . . | . . . | . . . | . . . |
| y + s | K | XXXXXXX | XXX |
| . . . | . . . | . . . | . . . |
| . . . | . . . | . . . | . . . |
| . . . | . . . | . . . | . . . |
| y + 2s | P | XXXXX | XXXXX |
| . . . | . . . | . . . | . . . |
| . . . | . . . | . . . | . . . |
| . . . | . . . | . . . | . . . |
| . . . | . . . | . . . | . . . |
| . . . | . . . | . . . | . . . |
| . . . | . . . | . . . | . . . |
| . . . | . . . | . . . | . . . |
| y + p.s | 0 | XXXXXXX | XXXXXX |
| . . . | . . . | . . . | . . . |
| . . . | . . . | . . . | . . . |

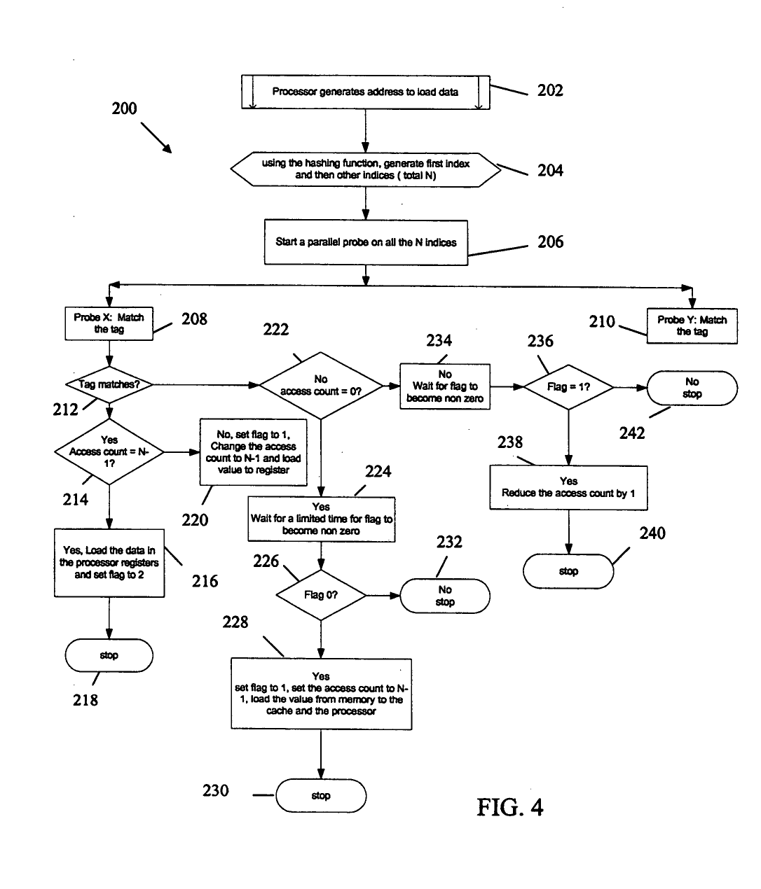

Referring to FIG. 4, a more detailed description of the method 200 of operation of an N-way pseudo set associative cache is now described. The processor 102 generates an address to load data at 202. The N way pseudo-associative cache memory has hash indices that can be probed in parallel. The hash indices point to the memory parts. If an address sought by the processor hashes to one of these N locations, other N−1 can be generated using the hashed index. Each of these N hash locations (parts) uses the ranking as an access count A that varies from 0 to N−1. The access count is a measure of relative importance of a hash location. The hashing function is used at 204 to generate a first index and other indices.

At 206 a parallel probe on all of the indices is conducted for all indices which correspond to the parts of the memory. A probe, probe X at 208 checks to see whether the tag matches, as do the other probes including for example probe Y at 210. The rest of the process occurs for each of the probes although only the process for probe X is shown for clarity.

At 212 it is determined whether the tag matches. If the tag matches at 214 it is checked to see whether the access count (ranking) also is at the highest value. If the access count is equal to the maximum value N−1 at 216 data is loaded to the processor and a flag is set to 2. The process for that probe then stops at 218.

If the access count is not at the maximum value at 214 then the process proceeds to 220. The flag is set to 1 and the access count is set to the maximum value, that is N−1, and the value at that address is loaded into the processor. The process for that probe then stops.

If the tag does not match at 212 the process proceeds to step 222. At step 222 it is checked to see whether the access count equals the minimum value, which in this embodiment is 0. If the access count is 0 the process waits for a limited amount of time at 224 for the flag to become non 0. After the amount of time the flag is checked at 226 to see whether it is 0. If the flag is 0 at 228 then it is set to 1, the access count is set to the maximum value, memory is loaded from the next highest level of memory to the cache and then loaded from the cache to the processor. The process for that probe then stops at 230.

In the event the flag is not 0 at 226, the process stops at 232.

If as a result of the check at 222 the access count is not equal to 0, the process waits at 234 for the flag to become non-zero. After this period of time the probe checks at 236 to see whether the flag has a value of 1. If the flag's value is 1 then at 238 the access count is reduced by 1 and then the process for that probe stops at 240.

In the event that the flag is not equal to 1 at the check 236 then the process stops at 242.

Following is an equivalent algorithm:

```
get address
generate primary hash index
generate N−1 multiple/secondary hash indices.
set the flag F to 0
start parallel probe in all the index locations
probes :
if cache hit :
if access count = N−1
        set flag F to 2.
        return value to the processor
    else
        increment my access count
        set Flag F to 1.
if cache miss
if my access count 0
counted loop on F to have a value other than 0.
if F is 0
            load value in cache
            set flag F to 1
            set my access count to N−1
return value to the processor
        if F is 1 or 2
            do nothing
    else
        wait for F to become 1 or 2.
        if F = 1
            reduce my access count.
        if F = 2
            do nothing
```

### EXAMPLE

The above described technique can be better understood by looking at an exemplary implementation. Let us again assume N=4. That means the cache would be a 4 way pseudo set associative cache. The range of ranking (access count) of a particular set can be from 0 to 3. Initially the access count of all the cache entries is 0.

For clarity, all the following tables which represent the memory structure show only the cache locations of a particular set. The first column in these tables indicates the index in the cache. The second column is the access count. The third and fourth columns are the data block and the cache tag. The cache tag is used to validate the cache entry.

Initially the cache entries for a particular set would be as:

| | | | |
|---|---|---|---|
| A | 0 | xxxxx | Xxxx |
| B | 0 | xxxxxxx | Xxxxxx |
| C | 0 | xx | Xxx |
| D | 0 | xxx | Xxxx |

When a primary hash indexes to one of these four locations, the other three are generated from it. A parallel probe would result a miss as the cache line is not loaded before. Since the access count of all the locations is 0, each probe waits for a finite time for the flag to become non-zero. Once the value is loaded in one of these locations (say C), the access count of it becomes 3 (N−1) and the cache looks like this:

| | | | |
|---|---|---|---|
| A | 0 | xxxxx | Xxxx |
| B | 0 | xxxxxxx | Xxxxxx |
| C | 3 | xxxxxxxxxxx | Xxxxxxxxxxxxx |
| D | 0 | xxx | Xxxx |

For the second miss, the access count of C would be reduced by 1 and one of the A, B or D (say A) locations would have the newly loaded data block as follows:

| | | | |
|---|---|---|---|
| A | 3 | xxxxx | Xxxx |
| B | 0 | xxxxxxx | Xxxxxx |
| C | 2 | xx | Xxx |
| D | 0 | xxx | Xxxx |

Once all the locations are filled the cache looks like this:

| | | | |
|---|---|---|---|
| A | 1 | xxxxx | Xxxx |
| B | 3 | xxxxxxx | Xxxxxx |
| C | 0 | xx | Xxx |
| D | 2 | xxx | Xxxx |

Now suppose a cache-hit occurs at A, the access count of A would be set to 3 and all others would be reduced by 1 (if it is not already 0). The probe for A would set the flag to 1, which would be set to 0 once all the probes finish as follows:

| | | | |
|---|---|---|---|
| A | 3 | xxxxx | Xxxx |
| B | 2 | xxxxxxx | Xxxxxx |
| C | 0 | xx | Xxx |
| D | 1 | xxx | Xxxx |

Now suppose a cache-miss occurs. The probe for C would continue with loading and then set the value of the flag to 1. Access count of C would be 3 and for others it would be decremented by 1 as follows:

| | | | |
|---|---|---|---|
| A | 2 | xxxxx | Xxxx |
| B | 1 | xxxxxxx | Xxxxxx |
| C | 3 | xx | Xxx |
| D | 0 | xxx | Xxxx |

If a cache-hit occurs at C, the probe for C would set the flag to 2 and return the value to processor. All other probes would do nothing. The table remains as it is.

It will be understood to persons skilled in the art that many modifications may be made without departing from the spirit and scope of the invention. Such modifications are intended to falling within the scope of the present invention.

In the claims of this application and in the description of the invention, except where the context requires otherwise due to express language or necessary implication, the words “comprise” or variations such as “comprises” or “comprising” are used in an inclusive sense, i.e. to specify the presence of the stated features but not to preclude the presence or addition of further features in various embodiments of the invention.

1. A method of controlling a cache memory comprising:
providing a memory device comprised of a plurality of cache memory parts;
probing the memory parts for a cache hit;
ranking each of the memory parts; and
fetching data from a higher level of memory into the lowest ranked memory part when there is a cache miss.

2. A method according to claim 1, wherein the memory device will be divided into the plurality of parts.

3. A method according to claim 2, wherein a hash index is generated to provide an offset of the data stored in each part of the memory device.

4. A method according to claim 3, wherein the start of each block of memory stored in each part of the memory device is indexed with the memory location of the block of data.

5. A method according to claim 4, wherein a memory location sought is checked against the index to determine whether the data at the memory location is contained in one of the parts of the memory device.

6. A method according to claim 1, wherein in the event of a cache hit in one of the parts of the memory device the one part is ranked highest.

7. A method according to claim 6, wherein in the event that there is a new highest ranked part, the ranking of the remaining parts is decreased.

8. A method according to claim 7, wherein in the event of a cache hit and there being no new highest ranked part the ranking remains the same.

9. A method according to claim 1, wherein in the event of a cache miss the part into which the data is fetch from higher level memory is ranked highest.

10. A method according to claim 1, wherein in the event that there is more than one of the parts with equal lowest ranking then one of the parts is chosen into which data is fetched from a higher level of memory, the remaining parts are unchanged.

11. A method according to claim 1, wherein a flag is provided to indicate a repeat cache hit, a new most recent part cache hit or a cache miss.

12. A method according to claim 11, wherein the flag is used to determine whether the ranking of memory parts requires updating.

13. A method according to claim 12, wherein in the event of a new most recent part cache hit or a cache miss then an update is required.

14. A computer cache memory comprising:
a memory device comprising a plurality of parts;
a probe device for probing the memory parts for a cache hit;
a ranking device for ranking each of the memory parts; and
a data fetching device for fetching data from a higher level of memory into the lowest ranked memory part when there is a cache miss.

15. A computer cache memory according to claim 14, wherein the ranking device ranks according to how recently a memory part is accessed.

168. A computer cache memory according to claim 14, wherein the ranking device ranks according to how frequently the memory part is accessed.

17. A computer cache memory according to claim 14, wherein the computer cache memory further comprises a data transfer device for transferring data from a part of the memory which has a cache hit to a microprocessor.

18. A computer cache memory comprising:
a memory device comprising a plurality of parts;
a probe device for probing the memory parts for a cache hit;
an ordering device for tracking the order of access to each of the memory parts; and
a data fetching device for fetching data from a higher level of memory into the memory part least recently accessed when there is a cache miss.
